(19) United States
(12) Patent Application Publication
(10) Pub. No.: US 2025/0019314 A1
(43) Pub. Date: Jan. 16, 2025

(54) PROCESS FOR PREPARING WATER-REDISPERSIBLE POLYMER POWDERS

(71) Applicant: WACKER CHEMIE AG, Munich (DE)

(72) Inventors: Markus BANNWARTH, Burghausen (DE); Sebastian KRICKL, Burghausen (DE); Timo MELCHIN, Mehring (DE); Hans-Peter WEITZEL, Reischach (DE); Heimo WÖLFLE, Traunstein (DE)

(73) Assignee: WACKER CHEMIE AG, Munich (DE)

(21) Appl. No.: 18/714,303

(22) PCT Filed: Nov. 30, 2021
(86) PCT No.: PCT/EP2021/083662

§ 371 Date: May 29, 2024

(51) Int. Cl. C04B 40/00; C04B 103/00; C08J 3/16

(52) U.S. Cl. CPC C04B 40/0025; C04B 40/0042; C08J 3/16; C04B 2103/0057

(57) ABSTRACT

Process for preparing protective colloid-stabilized polymers of ethylenically unsaturated monomers along with uses for the same. The process includes admixing aqueous dispersions of protective colloid-stabilized polymers of ethylenically unsaturated monomers with one or more drying aids and then drying the mixture. Where one or more salts of organic compounds containing 1 to 10 carbon atoms and optionally one or more protective colloids are used as drying aids. Where 0.1% to 20% by weight based on the dry weight of the aqueous dispersions of the protective colloid-stabilized polymers of salts of organic compounds containing 1 to 10 carbon atoms is used as drying aids.

The invention relates to processes for preparing polymers of ethylenically unsaturated monomers in the form of water-redispersible powders, to the thus obtainable water-redispersible polymer powders, and to the use thereof for example in adhesives or coating compositions, in particular in paints, or for the production of textile fabrics, or preferably as (co-)binder for construction adhesives, such as tile adhesives or integrated thermal insulation adhesives or other dry mortar applications.

Polymers in the form of water-redispersible powders (polymer powders) refer, as is known, to powder compositions obtainable by drying of the corresponding aqueous polymer dispersions in the presence of drying aids. Due to this production process, the finely divided polymer resin of the dispersion is usually encased with polymeric drying aids. During drying, the drying aid acts like a jacket that prevents the particles from sticking together irreversibly. When the polymer powders are redispersed in water, the drying aid dissolves, and an aqueous redispersion is formed in which the original polymer particles (primary polymer particles) are as far as possible present once again (Schulze J. in TIZ, No. 9, 1985).

Examples of established drying aids include polyvinyl alcohols, polyvinyl acetals or ionic and nonionic polymers of for example vinylpyrrolidone, (meth)acrylamides or acrylic acid, and polysaccharides (or polysaccharide derivatives) and proteins. For example, EP632096 describes the use of polyvinyl alcohols as drying aids for the preparation of polymer powders. EP770640 recommends polyelectrolytes for this purpose. EP78449 and EP407889 mention naphthalenesulfonic acid-formaldehyde and phenolsulfonic acid-formaldehyde condensation products, respectively. EP134451 teaches starches or proteins. Such drying aids do lead to good stabilization and blocking stability of the polymer powders and result in stable aqueous dispersions after redispersion. However, the disadvantage of standard drying aids is that the redispersion of such polymer powders is characterized by low breakdown kinetics and accordingly is time-consuming. Another disadvantage is that such standard, polymer-based drying aids lead to redispersions with relatively high viscosity and, when used in application formulations, also increase the viscosity thereof. Higher-viscosity application formulations however are stiffer and thus more difficult to process and can require the use of plasticizers or relatively large proportions of solvent, this interfering with the formulation and making the formulation more complex, more expensive and often less efficient.

Against this background, the object was to provide polymers of ethylenically unsaturated monomers in the form of water-redispersible powders that can be redispersed more rapidly in water and/or result in aqueous redispersions or application formulations with lower viscosity.

The object was surprisingly achieved using drying aids that comprise ≥60% by weight, based on the total weight of the drying aids, of salts of organic compounds containing 1 to 10 carbon atoms.

WO2004/092094 describes polymer powders with conventional drying aids, also called spraying aids, to which alkali (ne earth) metal salts of (in) organic acids can be added at any time as setting accelerators for hydraulically setting systems.

The invention provides processes for preparing polymers of ethylenically unsaturated monomers in the form of water-redispersible powders (polymer powders) by admixing aqueous dispersions of polymers of ethylenically unsaturated monomers with one or more drying aids and then drying the mixture, characterized in that the drying aids comprise ≥60% by weight, based on the total weight of the drying aids, of one or more salts of organic compounds containing 1 to 10 carbon atoms.

The invention further provides polymers of ethylenically unsaturated monomers in the form of water-redispersible powders obtainable by the process according to the invention.

The drying aids are added to the aqueous polymer dispersions, that is to say after they have been produced by means of polymerization. This generally has the result that the drying aids are not incorporated into the polymer particles—in contrast to any emulsifiers, protective colloids or other stabilizers that are used in the polymerization to stabilize the polymerization mixture. Other auxiliaries or additives for the polymerization, such as initiators, are also either bonded directly to the polymer chains via covalent bonds or incorporated into the polymer particles or encapsulated by the polymers in the course of the polymerization. In contrast thereto, the drying aids generally encase the individual polymer particles as a result of their addition after the polymerization. After the aqueous polymer dispersions have been dried, the polymer primary particles are generally encased by a drying aid casing, with the result that the individual polymer primary particles are isolated from one another and therefore do not irreversibly agglomerate, block or cake. After the polymer powders have been redispersed in water, the polymer primary particles are generally released again.

The salts of organic compounds containing 1 to 10 carbon atoms are also referred to hereinafter as organic salts for short.

The organic salts contain preferably 1 to 8, particularly preferably 1 to 5, most preferably 1 to 3 carbon atoms and most preferably of all 1 carbon atom.

The organic salts have molecular weights of preferably ≤1000 g/mol, particularly preferably ≤200 g/mol and most preferably ≤100 g/mol.

The organic compounds of the salts preferably bear one or more functional groups selected from the group comprising carboxylic acid, sulfonic acid, sulfinic acid, sulfuric acid, ammonium, amine, phosphoric acid, phosphonic acid, phosphinic acid groups. Preference is given to carboxylic acid and sulfonic acid groups. Particular preference is given to carboxylic acid groups.

Preferably, the organic salts bear 1 to 5 functional groups, in particular at least two carboxylic acid groups or at least one carboxylic acid group and at least one hydroxyl group. Particularly preferably, the organic salts bear only one functional group.

The organic salts are preferably saturated and particularly preferably do not bear any ethylenically unsaturated groups. The organic salts are preferably aliphatic.

The organic compounds of the salts are preferably in the form of cations and particularly preferably in the form of anions.

As counterions, the organic compounds of the salts preferably have alkaline earth metal, alkali metal or ammonium ions. Preference is given to alkali metal ions. Preferred alkali metal ions are lithium ions, potassium ions and in particular sodium ions. In a preferred embodiment, the organic salts are not in the form of lithium salts.

Examples of organic salts are monocarboxylates, such as formates, acetates, propanate or butyrates; hydroxycarboxylates, such as hydroxypropanates, hydroxybutyrates, glycolates, lactates or glycerates; oxocarboxylates, such as glyoxylates, oxobutanates or acetoacetates; dicarboxylates, such as oxalates, malonates, methylmalonates, pyruvates, succinates, oxaloacetates, malates or tartrates; or ethylenically unsaturated carboxylates, such as acrylates, fumarates, maleates and crotonates, in particular the alkali metal salts thereof, preferably the sodium salts thereof. Preferred organic salts are formates, acetates, glyoxylates, glycolates, propanates, in particular the alkali metal salts thereof, preferably the sodium salts thereof. Most preferred organic salts are sodium formates.

The drying aids comprise preferably ≥70% by weight, more preferably ≥80% by weight, more preferably still ≥90% by weight, particularly preferably ≥95% by weight and very particularly preferably ≥98% by weight of one or more organic salts, based on the total weight of the drying aids. Most preferably, exclusively organic salts are used as drying aids.

In addition to the organic salts, one or more protective colloids may optionally be used as drying aids. Examples of such protective colloids are polyvinyl alcohols; polyvinylpyrrolidones; polysaccharides in water-soluble form such as starches (amylose and amylopectin), celluloses and the carboxymethyl, methyl, hydroxyethyl and hydroxypropyl derivatives thereof; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and the water-soluble copolymers thereof; melamine-formaldehydesulfonates, naphthalene-formaldehydesulfonates, styrene-maleic acid copolymers and vinyl ether-maleic acid copolymers. Preference is given here to polyvinyl alcohols.

The drying aids comprise preferably ≤40% by weight, more preferably ≤20% by weight, more preferably still ≤10% by weight and particularly preferably ≤5% by weight of protective colloids, based on the total weight of the drying aids. Most preferably, no protective colloids are used as drying aids.

The weight ratio of the organic salts to the protective colloids used as drying aids is preferably ≥2, more preferably ≥5, more preferably still ≥10% by weight and particularly preferably ≥30.

Preferably 0.1% to 20% by weight, particularly preferably 0.5% to 15% by weight and most preferably 1% to 10% by weight of organic salts is used as drying aids, based on the dry weight of the polymer dispersion or the total weight of the polymer powders.

The polymers of ethylenically unsaturated monomers are based for example on one or more monomers selected from the group comprising vinyl esters, (meth)acrylic esters, vinylaromatics, olefins, 1,3-dienes and vinyl halides.

Suitable vinyl esters are for example those of carboxylic acids having 1 to 15 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 carbon atoms, for example VeoVa9R or VeoVa10R (trade names of Resolution). Particular preference is given to vinyl acetate.

Suitable monomers from the group of acrylic esters or methacrylic esters are for example esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate. Particular preference is given to methyl acrylate, methyl methacrylate, n-butyl acrylate, t-butyl acrylate and 2-ethylhexyl acrylate.

Preferred vinylaromatics are styrene, methylstyrene and vinyltoluene. A preferred vinyl halide is vinyl chloride. The preferred olefins are ethylene and propylene, and the preferred dienes are 1,3-butadiene and isoprene.

It is optionally also possible to copolymerize 0% to 10% by weight, preferably 0.1% to 5% by weight, based on the total weight of the monomers, of auxiliary monomers. Examples of auxiliary monomers are ethylenically unsaturated mono- and dicarboxylic acids, preferably acrylic acid, methacrylic acid, fumaric acid and maleic acid; ethylenically unsaturated carboxamides and carbonitriles, preferably acrylamide and acrylonitrile; mono- and diesters of fumaric acid and maleic acid, such as the diethyl and diisopropyl esters, and maleic anhydride; ethylenically unsaturated sulfonic acids or salts thereof, preferably vinylsulfonic acid, and 2-acrylamido-2-methylpropanesulfonic acid. Further examples are precrosslinking comonomers such as polyethylenically unsaturated comonomers, for example diallyl phthalate, divinyl adipate, diallyl maleate, allyl methacrylate or triallyl cyanurate, or postcrosslinking comonomers, for example acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers such as the isobutoxy ether or ester of N-methylolacrylamide, of N-methylolmethacrylamide and of N-methylolallyl carbamate. Also suitable are epoxy-functional comonomers such as glycidyl methacrylate and glycidyl acrylate. Further examples are silicon-functional comonomers, such as acryloxypropyltri (alkoxy)- and methacryloxypropyltri (alkoxy) silanes, vinyltrialkoxysilanes and vinylmethyldialkoxysilanes, where the alkoxy groups present may for example be ethoxy and ethoxypropylene glycol ether radicals. Mention should also be made of monomers having hydroxy or CO groups, for example hydroxyalkyl methacrylates and acrylates such as hydroxyethyl, hydroxypropyl or hydroxybutyl acrylate or methacrylate, and compounds such as diacetone acrylamide and acetylacetoxyethyl acrylate or methacrylate.

Preference is given to copolymers of vinyl acetate with 1% to 50% by weight of ethylene; copolymers of vinyl acetate with 1% to 50% by weight of ethylene and 1% to 50% by weight of one or more further comonomers from the group of vinyl esters having 1 to 12 carbon atoms in the carboxyl radical such as vinyl propionate, vinyl laurate, vinyl esters of alpha-branched carboxylic acids having 9 to 13 carbon atoms such as VeoVa9, VeoVa10, VeoVa11; copolymers of vinyl acetate, 1% to 50% by weight of ethylene and preferably 1% to 60% by weight of (meth)acrylic esters of unbranched or branched alcohols having 1 to 15 carbon atoms, in particular n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 9 to 11 carbon atoms, and 1% to 30% by weight of (meth)acrylic esters of unbranched or branched alcohols having 1 to 15 carbon atoms, in particular n-butyl acrylate or 2-ethylhexyl acrylate, which also contain 1% to 40% by weight of ethylene; copolymers with vinyl acetate, 1% to 50% by weight of ethylene and 1% to 60% by weight of vinyl chloride; where the polymers may also contain the auxiliary monomers mentioned in the amounts mentioned, and the figures in % by weight add up to 100% by weight in each case.

Preference is also given to (meth)acrylic ester polymers, such as copolymers of n-butyl acrylate or 2-ethylhexyl acrylate or copolymers of methyl methacrylate with n-butyl acrylate and/or 2-ethylhexyl acrylate; styrene-acrylic ester copolymers with one or more monomers from the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; where the polymers may also contain the auxiliary monomers mentioned in the amounts mentioned, and the figures in % by weight add up to 100% by weight in each case.

Most preferred are copolymers with vinyl acetate and 5% to 50% by weight of ethylene; or copolymers with vinyl acetate, 1% to 50% by weight of ethylene and 1% to 50% by weight of a vinyl ester of α-branched monocarboxylic acids having 9 to 11 carbon atoms; or copolymers with 30% to 75% by weight of vinyl acetate, 1% to 30% by weight of vinyl laurate or vinyl esters of an alpha-branched carboxylic acid having 9 to 11 carbon atoms, and 1% to 30% by weight of (meth)acrylic esters of unbranched or branched alcohols having 1 to 15 carbon atoms, which also contain 1% to 40% by weight of ethylene; or copolymers with vinyl acetate, 5% to 50% by weight of ethylene and 1% to 60% by weight of vinyl chloride.

The monomers and the proportions by weight of the comonomers are selected so as to result in a glass transition temperature Tg of −25° C. to +35° C., preferably −10° C. to +25° C., particularly preferably −10° C. to +20° C. The glass transition temperature Tg of the polymers can be determined in a known manner by differential scanning calorimetry (DSC). An approximate Tg can also be precalculated by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn is the glass transition temperature in kelvin of the homopolymer of the monomer n. Tg values for homopolymers are listed in Polymer Handbook 2nd Edition, J. Wiley & Sons, New York (1975).

The polymers are preferably obtainable by means of emulsion polymerization or suspension polymerization of one or more ethylenically unsaturated monomers in aqueous medium.

The polymers are preferably prepared by the emulsion polymerization method.

The polymerization temperature is preferably between 40° C. and 100° C., particularly preferably between 60° C. and 90° C. In the copolymerization of gaseous comonomers such as ethylene, 1,3-butadiene or vinyl chloride, it is also possible to work under pressure, generally between 5 bar and 100 bar.

The polymerization is initiated with the water-soluble or monomer-soluble initiators or redox initiator combinations commonly used for emulsion polymerization or suspension polymerization. Examples of water-soluble initiators are the sodium, potassium and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, isopropylbenzene monohydroperoxide, azobisisobutyronitrile. Examples of monomer-soluble initiators are dicetyl peroxydicarbonate, dicyclohexyl peroxydicarbonate, dibenzoyl peroxide. The initiators mentioned are generally used in an amount of 0.001% to 1.0% by weight, preferably 0.002% to 0.5% by weight, in each case based on the total weight of the monomers.

Redox initiators used are combinations of the initiators mentioned and reducing agents. Suitable reducing agents are the sulfites and bisulfites of alkali metals and of ammonium, for example sodium sulfite, the derivatives of sulfoxylic acid such as zinc or alkali metal formaldehyde sulfoxylates, for example sodium hydroxymethanesulfinate, and ascorbic acid. The amount of reducing agent is generally 0.001% to 1.0% by weight, preferably 0.002% to 0.5% by weight, in each case based on the total weight of the monomers.

Substances that act as chain transfer agents can be used during the polymerization to control the molecular weight. If chain-transfer agents are used, they are usually used in amounts between 0.01% to 5.0% by weight, based on the monomers to be polymerized, and are metered in separately or else having been premixed with reaction components. Examples of such substances are n-dodecyl mercaptan, tert-dodecyl mercaptan, mercaptopropionic acid, methyl mercaptopropionate, isopropanol and acetaldehyde.

Suitable protective colloids for the polymerization are polyvinyl alcohols; polyvinyl acetals; polyvinylpyrrolidones; polysaccharides in water-soluble form such as starches (amylose and amylopectin), celluloses and the carboxymethyl, methyl, hydroxyethyl, hydroxypropyl derivatives thereof, dextrins and cyclodextrins; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and the water-soluble copolymers thereof; melamine-formaldehydesulfonates, naphthalene-formaldehydesulfonates, styrene-maleic acid copolymers and vinyl ether-maleic acid copolymers.

Water-insoluble, film-forming polyaddition and polycondensation polymers such as polyurethanes, polyesters, polyethers, polyamides, melamine-formaldehyde resins, naphthalene-formaldehyde resins, phenol-formaldehyde resins, optionally also in the form of their oligomeric preproducts, may also be suitable as protective colloids for the polymerization.

Preference is given to partially hydrolyzed or fully hydrolyzed polyvinyl alcohols having a degree of hydrolysis of 80 to 100 mol %, in particular partially hydrolyzed polyvinyl alcohols having a degree of hydrolysis of 80 to 95 mol % and a Höppler viscosity of 1 to 30 mPas (Höppler method at 20° C., DIN 53015) in 4% aqueous solution. Preference is also given to partially hydrolyzed, hydrophobically modified polyvinyl alcohols having a degree of hydrolysis of 80 to 95 mol % and a Höppler viscosity of 1 to 30 mPas in 4% aqueous solution. Examples of these include partially hydrolyzed copolymers of vinyl acetate with hydrophobic comonomers such as isopropenyl acetate, vinyl pivalate, vinyl ethylhexanoate, vinyl esters of saturated alpha-branched monocarboxylic acids having 5 or 9 to 11 carbon atoms, dialkyl maleates and dialkyl fumarates such as diisopropyl maleate and diisopropyl fumarate, vinyl chloride, vinyl alkyl ethers such as vinyl butyl ether, olefins such as ethene and decene. The proportion of the hydrophobic units is preferably 0.1% to 10% by weight, based on the total weight of the partially hydrolyzed polyvinyl alcohol. Mixtures of the polyvinyl alcohols mentioned may also be used.

Most preferred are polyvinyl alcohols having a degree of hydrolysis of 85 to 94 mol % and a Höppler viscosity of 3 to 15 mPas (Höppler method at 20° C., DIN 53015) in 4% aqueous solution. The protective colloids mentioned are obtainable by means of processes known to those skilled in the art and are generally added in the polymerization in a total amount of 1% to 20% by weight, based on the total weight of the monomers.

If polymerization is effected in the presence of emulsifiers, the amount thereof is 0.5% to 5% by weight based on the amount of monomers. Suitable emulsifiers are anionic, cationic and nonionic emulsifiers, for example anionic surfactants, such as alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl- or alkylarylsulfonates having 8 to 18 carbon atoms, esters and monoesters of sulfosuccinic acid with monohydric alcohols or alkylphenols, or nonionic surfactants such as alkyl polyglycol ethers or alkylaryl polyglycol ethers having 8 to 40 ethylene oxide units.

On completion of the polymerization, residual monomers can be removed by postpolymerization employing known methods, generally by redox catalyst-initiated postpolymerization. Volatile residual monomers can also be removed by means of distillation, preferably under reduced pressure, and optionally while passing inert entraining gases through or over, such as air, nitrogen or water vapor.

The thus obtainable aqueous dispersions have a solids content of 30% to 75% by weight, preferably of 50% to 60% by weight.

The polymers may for example be in the form of aqueous dispersions, in particular protective colloid-stabilized aqueous dispersions. Preferred protective colloids are polyvinyl alcohols, such as partially hydrolyzed or fully hydrolyzed polyvinyl alcohols, in particular having a degree of hydrolysis of 80 to 100 mol %. Particular preference is given to partially hydrolyzed polyvinyl alcohols having a degree of hydrolysis of 80 to 94 mol % and a Höppler viscosity of in particular 1 to 30 mPas (Höppler method at 20° C., DIN 53015) in 4% aqueous solution. The protective colloids mentioned are obtainable by means of processes known to those skilled in the art. The protective colloids for stabilizing the dispersion are preferably added in a total amount of 1% to 20% by weight, in particular 1% to 10% by weight, based on the total weight of the polymers.

The viscosity of the mixture to be dried is adjusted via the solids content such that a value of <1500 mPas (Brookfield viscosity at 20 revolutions and 23° C.), preferably <500 mPas, is obtained. The solids content of the mixture to be dried is >35%, preferably >40%.

To prepare the water-redispersible polymer powders, the aqueous dispersions are dried after addition of the drying aids according to the invention, for example by means of fluidized bed drying, freeze drying or spray drying. Preference is given to spray drying the dispersions. The spray drying is effected in standard spray-drying systems, where the atomization may be effected by means of one-, two- or multiphase nozzles or with a rotating disk. The exit temperature is generally chosen in the range of 45° C. to 120° C., preferably 60° C. to 90° C., depending on the system, Tg of the resin and desired degree of drying.

In the spraying for drying aqueous polymer dispersions, a content of up to 3% by weight of antifoam agent, based on the base polymer, has proven to be favorable in many cases. To increase storability by improving the blocking stability, particularly in the case of polymer powders with low glass transition temperature, the polymer powder obtained may be provided with an antiblocking agent (anticaking agent), preferably up to 30% by weight, based on the total weight of polymeric constituents. Examples of antiblocking agents are calcium carbonate or magnesium carbonate, talc, gypsum, silica, kaolins, metakaolin, calcined kaolin, silicates having particle sizes preferably in the range of 10 nm to 100 μm.

Further additives may be added during the drying in order to improve the performance properties. Further constituents of dispersion powder compositions that are present in preferred embodiments are for example pigments, fillers, foam stabilizers, hydrophobizing agents or cement plasticizers.

The polymers are preferably in the form of protective colloid-stabilized, water-redispersible powders. Dispersing the protective colloid-stabilized, water-redispersible polymer powders results in protective colloid-stabilized polymers in the form of aqueous redispersions.

The polymer powders are particularly suitable for use in construction chemical products. They may be used alone or in combination with conventional polymer dispersions or dispersion powders, optionally in conjunction with hydraulically setting binders such as cements (portland cement, aluminate cement, trass cement, slag cement, magnesia cement, phosphate cement), gypsum and waterglass for the production of leveling compounds, construction adhesives, renders, filling compounds, jointing mortars, sealing slurries or paints. Among construction adhesives, tile adhesives or integrated thermal insulation adhesives are preferred areas of use for the dispersion powder compositions. Preferred areas of application for the polymer powders are leveling compounds; particularly preferred leveling compounds are self-leveling floor filling compounds and screeds.

Furthermore, the polymer powders are generally suitable as binders for coating compositions or adhesives, in particular for paints, fibers, textiles, leather, paper or carpets. Preference is also given to the use of the polymer powders as binders for the binding of fiber materials, in particular for the production of textile fabrics, such as nonwovens, knitted and woven goods, leathers and furs, or carpets, or as binders for construction coatings, in particular aqueous emulsion paints or powder paints.

The process according to the invention surprisingly leads to polymer powders that can be redispersed rapidly in water and result in aqueous redispersions with low viscosities and also aqueous application formulations, such as mortars, having relatively low viscosities.

The examples which follow serve for further elucidation of the invention.

### Preparation of the Dispersions:

An aqueous dispersion of a vinyl acetate-ethylene copolymer was prepared by conventional emulsion polymerization. The copolymer had a glass transition temperature Tg of −15° C. The dispersion was stabilized with 6.5% by weight of polyvinyl alcohol (degree of hydrolysis: 88 mol %, Höppler viscosity: 4 mPas in 4% aqueous solution).

### Preparation of the Polymer Powders:

An aqueous dispersion of the vinyl acetate-ethylene copolymer was admixed with drying aids according to the data in Table 1 and then the mixture was dried by spray drying in a manner conventional per se at an entry temperature of 130° C. and an exit temperature of 80° C., whereby a redispersible polymer powder was obtained. To the polymer powder was added 6% by weight of kaolin and 10% by weight of calcium carbonate as anticaking agents.

TABLE 1
Drying aids of the polymer powders:

| | Drying aid^{a)} |
|---|---|
| Example 1 | 6.5% by weight of sodium formate |
| Example 2 | 13% by weight of sodium formate |
| Example 3 | 10% by weight of calcium formate |
| Comparative Example 1 | none |
| Comparative Example 2 | 5% by weight of partially hydrolyzed |
| | polyvinyl alcohol |

^{a)}based on the polymer content of the dispersion (solid/solid).

Determination of the tube sedimentation behavior (TS) of the polymer powders: The sedimentation behavior of the aqueous redispersion of the polymer powder serves as a measure of the completeness of the redispersion. The better the redispersion, the more homogeneous and finer the distribution of the redispersion in the final application and the lower the tube sedimentation.

The respective polymer powder was converted into an aqueous redispersion having a solids content of 10% by adding water, mineral fillers and a methylcellulose under the action of strong shear forces.

The sedimentation behavior was determined by diluting the aqueous redispersion with water to a solids content of 0.5% and filling a graduated tube with 100 ml of this dispersion and measuring the height of the sedimented solid. The values are reported in cm of sedimentation after 1 hour and after 24 hours. The lower the tube sedimentation value, the better the redispersibility of the powders.

The values obtained for the sedimentation behavior (TS) are listed in Table 2 below.

### Determination of the Blocking Resistance (BR):

For determining the blocking resistance, the powder under test was filled into an iron tube with a screw thread and was then loaded with a metal ram. It was stored under loading in a drying cabinet at 50° C. for 24 hours. After cooling to room temperature, the powder was removed from the tube and the blocking stability was determined qualitatively by crushing the powder (s. Table 2).

The blocking stability was classified as follows:
1=very good blocking stability
2=good blocking stability
3=satisfactory blocking stability
4=not blocking-stable, powder no longer free-flowing after crushing.

TABLE 2
Properties of the polymer powders:

| | Sedimentation | Sedimentation | Blocking |
|---|---|---|---|
| | behavior after | behavior after | resistance |
| | 1 h | 24 h | BR |
| Example 1 | 0.2 | 1.2 | 3.0 |
| Example 2 | 0.2 | 0.4 | 2.5 |
| Example 3 | 0.3 | 0.5 | 3.0 |
| Comparative Example 1 | 5.2 | >7 | 4.0 |
| Comparative Example 2 | 0.8 | 2.0 | 3.5 |

Significantly increased tube sedimentation was measured for the polymer powder of Comparative Example 1 without drying aid. This polymer powder redispersed very poorly and the redispersion was very coarse.

The TS value is decreased significantly when drying aids are added. Surprisingly, the TS value for Examples 1 to 3 with drying aids according to the invention was even below the TS value of Comparative Example 2, in which the standard drying aid polyvinyl alcohol was used.

The redispersions of the polymer powders according to the invention were at least as stable as conventional redispersions (Comparative Example 2).

Consequently, the organic salts according to the invention are perfectly suitable as efficient spray drying aids.

### Testing of the Redispersion Rate of the Polymer Powders:

The redispersion rate was determined via static light scattering and was investigated in a time-resolved manner. For this purpose, 100 mg of polymer powder was sprinkled into a water-filled measuring cell of a Beckman Coulter light scattering system (LS 13 320 model). With medium circulation (pump power 50%), time-resolved particle size distributions were recorded every minute via PIDS technology (Polarization Intensity Differential Scattering) in combination with laser diffraction. For the further evaluation, the median values of the distributions were normalized to start and end values and represented as a percentage of the redispersion progress of the fines fraction. Used as reference values were the median values of the powder used (0%) and a redispersion of the powder that was broken down under high shear forces after 15 minutes of shearing (100%).

The results of the testing are listed in Table 3.

TABLE 3
Redispersion rate of the polymer powders:

| | Fines fraction | Fines fraction | Fines fraction |
|---|---|---|---|
| | after 0 min | after 2 min | after 4 min |
| Example 1 | 0% | 65.2% | 95.8% |
| Example 2 | 0% | 94.3% | 96.2% |
| Example 3 | 0% | 23.4% | 51.5% |
| Comparative | n.b.^{a)} | n.b.^{a)} | n.b.^{a)} |
| Example 1 | | | |
| Comparative | 0% | 8.6% | 23.2% |
| Example 2 | | | |

^{a)}Value was not able to be determined because the redispersion was too coarse and clumpy.

Investigation of the influence of the polymer powders on the viscosity of mortars: The redispersible powders were stirred into the mortar mixture of Table 4 and the Brookfield viscosity (20 rpm) of the resulting mortar was measured. Used as redispersible powders were the polymer powders according to the data in Table 5:

TABLE 4
Mortar mixture:

| | Use amount in g |
|---|---|
| Portland cement | 100.00 |
| Aluminate cement | 100.00 |
| Fillers | 477.90 |
| Defoamer | 5.00 |
| Accelerator | 0.50 |
| Retarder | 0.60 |
| Sulfate carrier | 15.00 |
| Methylcellulose | 1.00 |
| Redispersible powder | 150.00 |
| Water | 150.00 |

The mortars were mixed by stirring with a kneading hook for 1 minute. After a rest time of 3 minutes and brief stirring again, the Brookfield viscosity was measured. The results are summarized in Table 5.

TABLE 5
Influence of the polymer powders on the viscosity of the mortars:

| Polymer powder | Viscosity of the mortars |
|---|---|
| none | 1500 mPas |
| Example 1 | 800 mPas |
| Example 2 | 1050 mPas |
| Example 3 | 2600 mPas |
| Comparative Example 1 | was not able to be mixed in homogeneously |
| | because it was too coarse and clumpy |
| Comparative Example 2 | 3600 mPas |

The examples according to the invention led to a mortar with reduced viscosity in comparison with the mortar of Comparative Example 2.

1-12. (canceled)

13. A process for preparing protective colloid-stabilized polymers of ethylenically unsaturated monomers, comprising:
admixing aqueous dispersions of protective colloid-stabilized polymers of ethylenically unsaturated monomers with one or more drying aids and then drying the mixture;
wherein one or more salts of organic compounds containing 1 to 10 carbon atoms and optionally one or more protective colloids are used as drying aids;
wherein the drying aids comprise ≥80% by weight, based on the total weight of the drying aids, of one or more salts of organic compounds containing 1 to 10 carbon atoms;
wherein 0.1% to 20% by weight based on the dry weight of the aqueous dispersions of the protective colloid-stabilized polymers of salts of organic compounds containing 1 to 10 carbon atoms is used as drying aids; and
wherein the one or more protective colloids are selected from the group comprising polyvinyl alcohols, polyvinylpyrrolidones, polysaccharides in water-soluble form, proteins, lignosulfonates, polyacrylic acid, polymethacrylic acid, copolymers of acrylates with carboxy-functional comonomer units, copolymers of methacrylates with carboxy-functional comonomer units, polyacrylamide, polymethacrylamide, polyvinylsulfonic acids and the water-soluble copolymers thereof, melamine-formaldehydesulfonates, naphthalene-formaldehydesulfonates, styrene-maleic acid copolymers and vinyl ether-maleic acid copolymers.

14. The process of claim 13, wherein the one or more salts of organic compounds used as drying aids bear one or more functional groups selected from the group comprising carboxylic acid, sulfonic acid, sulfinic acid, sulfuric acid, ammonium, amine, phosphoric acid, phosphonic acid and phosphinic acid groups.

15. The process of claim 13, wherein the one or more salts of organic compounds used as drying aids bear only one functional group.

16. The process of claim 13, wherein the one or more salts of organic compounds used as drying aids are selected from the group comprising alkali (ne earth) metal salts of monocarboxylates, dicarboxylates, hydroxycarboxylates, oxocarboxylates and ethylenically unsaturated carboxylates.

17. The process of claim 13, wherein the one or more salts of organic compounds used as drying aids are selected from the group comprising alkali (ne earth) metal salts of formates, acetates, propanates, butyrates, hydroxypropanates, hydroxybutyrates, glycolates, lactates, glycerates, glyoxylates, oxobutanates, acetoacetates, oxalates, malonates, methylmalonates, pyruvates, succinates, oxaloacetates, malates, tartrates, acrylates, fumarates, maleates and crotonates.

18. The process of claim 13, wherein alkali (ne earth) metal salts of formates are used as drying aids.

19. The process of claim 13, wherein the drying aids comprise ≥90% by weight based on the total weight of the drying aids of one or more salts of organic compounds containing 1 to 10 carbon atoms.

20. The process of claim 13, wherein exclusively salts of organic compounds containing 1 to 10 carbon atoms are used as drying aids.

21. The process of claim 13, wherein 0.5% to 15% by weight of salts of organic compounds containing 1 to 10 carbon atoms is used as drying aids based on the dry weight of the polymer dispersion.

22. The process of claim 13, wherein the polymers of ethylenically unsaturated monomers are based on one or more monomers selected from the group comprising vinyl esters, (meth)acrylic esters, vinylaromatics, olefins, 1,3-dienes and vinyl halides.

23. The process of claim 13, wherein the protective colloid-stabilized polymers of ethylenically unsaturated monomers obtained are water-redispersible powders.

24. The process of claim 13, wherein the protective colloid-stabilized polymers of ethylenically unsaturated monomers obtained are used as binders for coating compositions or adhesives, in particular for paints, textiles, paper or carpets.

25. The process of claim 13, wherein the protective colloid-stabilized polymers of ethylenically unsaturated monomers obtained are used in leveling compounds, construction adhesives, tile adhesives, integrated thermal insulation adhesives, renders, filling compounds, jointing mortars, sealing slurries or paints.
